(19) United States
(12) Patent Application Publication
(10) Pub. No.: US 2006/0179348 A1
(43) Pub. Date: Aug. 10, 2006

(54) Method and apparatus for representing, managing and problem reporting in RFID networks

(76) Inventors: Danilo Florissi, Briarcliff Manor, NY (US); Patricia Florissi, Briarcliff Manor, NY (US); Jeffrey A. Schriesheim, Lexington, MA (US)

Correspondence Address: Carl A. Giordano, Esq.;EMC Corporation, Office of the General Counsel, 7th flr., 44 S. Broadway, White Plains, NY, 10601, US

(21) Appl. No.: 11/325,108

(22) Filed: Jan. 3, 2006

Related U.S. Application Data
(63) Continuation-in-part of application No. 10/813,842, filed on Mar. 31, 2004.

(51) Int. Cl. G06F 11/00

(52) U.S. Cl. 714/30

(57) ABSTRACT

A method, system and computer product for determining the source of problems in a Radio Frequency Identification (RFID) network containing a plurality of component are disclosed. The method comprises the steps of representing selected ones of the plurality of components, providing a mapping between a plurality of observable events and a plurality of causing events occurring in components, wherein the observable events are at least associated with each of the at least one components, and determining at least one likely causing event based on at least one of the plurality of observable events by determining a measure between each of a plurality of values associated with the plurality of observable events and the plurality of causing events. In one aspect of the invention, selected ones of the plurality of components are represented in a plurality of domains, wherein for each domain, at least one of the plurality of components is associated with at least two of the domains, providing a mapping between a plurality observable events and a plurality of causing events occurring in components in each of the domains, wherein selected ones of the observable events are associated with each of the at least one component associated with at least two of the domains, determining at least one likely causing event based on at least one of the plurality of observable events by determining a measure between each of a plurality of values associated with the plurality of observable events and the plurality of causing events in selected domains; and determining a likely causing event by correlating the likely causing events associated with each of the domains.

### CLAIM OF PRIORITY

This application is a continuation-in-part, and claims the benefit pursuant to 35 USC §120 of the earlier filing date, of co-pending U.S. patent application Ser. No. 10/813,842, entitled “Method and Apparatus for Multi-Realm System Modeling” filed Mar. 31, 2004, the contents of which are incorporated by reference herein

### RELATED APPLICATIONS

This application is related to co-pending U.S. patent application Ser. No. 11/263,689 entitled “Apparatus and Method for Event Correlation and Problem Reporting,” which is a continuation of U.S. patent application Ser. No. 11/034,192, entitled “Apparatus and Method for Event Correlation and Problem Reporting,” filed on Jan. 12, 2005, now U.S. Pat. No. ______, which is a continuation of U.S. patent application Ser. No. 10/400,718, entitled “Apparatus and Method for Event Correlation and Problem Reporting,” filed on Mar. 27, 2003, now U.S. Pat. No. 6,868,367, which is a continuation of U.S. patent application Ser. No. 09/809,769 filed on Mar. 16, 2001, now abandoned, which is a continuation of U.S. patent application Ser. No. 08/893,263, now U.S. Pat. No. 6,249,755, filed on Jul. 15, 1997, which is a continuation of U.S. patent application Ser. No. 08/679,443, now U.S. Pat. No. 5,661,668, filed on Jul. 12, 1996, which is a continuation of application Ser. No. 08/465,754, filed on Jun. 6, 1995, now abandoned, which is a continuation of U.S. patent application Ser. No. 08/249,282, now U.S. Pat. No. 5,528,516, filed on May 25, 1994.

A portion of the disclosure of this patent document contains illustrations of EMC Smarts network model, which subject to copyright protection. The copyright owner, EMC Corporation, has no objection to the facsimile reproduction by anyone of the patent document or the patent disclosure, as it appears in the Patent and Trademark Office patent file or records, but otherwise reserves all copyright rights whatsoever.

### BACKGROUND

This invention relates generally to networks, and more specifically to apparatus and methods for modeling, managing, analyzing and determining root cause errors in Radio Frequency Identification (RFID) networks.

RF Identification (RFID) technology is an automatic identification method, relying on remotely retrieving data from RFID transponders embodied in a package or product. RFID transponders or tags may be attached to or incorporated into a product, animal or person to provide a unique identification of the product, animal or person. RFID tags are known to contain antennas that enable them to receive and respond to radio-frequency queries from an RFID transceiver. RFID tags may by either passive, semi-active or active wherein passive tags require no internal power source and are more reflective of queries and active tags require an internal power source. Passive RFID tags operate on a minute electrical current induced in an attached antenna by an incoming RF signal that provides just enough power for the circuitry to power up and transmit a response. Semi-passive RFID tags are similar to passive RFID tags except they include a small battery. The battery allows the circuitry to be constantly powered. This removes the need for the antenna to collect power from the incoming signal. Active tags or beacons have an internal power source that is used to power any circuitry and generate an outgoing signal. Active tags operate at a longer range than passive tags and may include additional memory that includes information in addition to the unique identification.

One example of an RFID network is an inventory control system used for the monitoring of the movement of packages. In an exemplary inventory control system data or information transmitted by the tag is read by an RFID reader. The tag may provide identification or location information or specifics regarding the product tagged, such as price, color, date of manufacture, etc. In a conventional RFID system, the tags are passed before an interrogator—i.e., RFID reader—that emits a signal to which the RFID tag provides a response. The information provided by the tag may then be passed to a host computer for further processing. For proper operation of such a monitoring system, a 100 percent reading ratio is a desired, but often unreachable, requirement for a successful application. Accuracy of reading tags, their performance in certain environments and the reliability requirements makes the active tag more attractive over passive tags. However, whether the tags are passive, semi-passive or active the dynamically changing position of tags within the network requires that the network elements, e.g., readers, be represented in a manner that the elements may be managed and problems in the network elements, when they occur, reported.

Hence, there is a need in the industry for a method and system for representing, analyzing and determining root cause errors and the impact of such errors in RFID networks.

### SUMMARY OF THE INVENTION

A method, system and computer product for determining the source of problems in a Radio Frequency Identification (RFID) network containing a plurality of component are disclosed. The method comprises the steps of representing selected ones of the plurality of components, providing a mapping between a plurality of observable events and a plurality of causing events occurring in components, wherein the observable events are at least associated with each of the at least one components; and determining at least one likely causing event based on at least one of the plurality of observable events by determining a measure between each of a plurality of values associated with the plurality of observable events and the plurality of causing events. In one aspect of the invention, selected ones of the plurality of components are represented in a plurality of domains, wherein for each domain, at least one of the plurality of components is associated with at least two of the domains, providing a mapping between a plurality observable events and a plurality of causing events occurring in components in each of the domains, wherein the observable events are at least associated with each of the at least one component associated with at least two of the domains, determining at least one likely causing event based on at least one of the plurality of observable events by determining a measure between each of a plurality of values associated with the plurality of observable events and the plurality of causing events in selected domains; and determining a likely causing event by correlating the likely causing events associated with each of the domains.

Other embodiments of the invention include a computerized device, configured to process all of the method operations disclosed herein as embodiments of the invention. In such embodiments, the computerized device includes a memory system, a processor, a communications interface and an interconnection mechanism connecting these components. The memory system is encoded with a load manager (or store process) application that when performed on the processor, produces a load manager (or store) process that operates as explained herein within the computerized device to perform all of the method embodiments and operations explained herein as embodiments of the invention.

Other arrangements of embodiments of the invention that are disclosed herein include software programs to perform the method embodiment steps and operations summarized above and disclosed in detail below. More particularly, a computer program product is disclosed that has a computer-readable medium including computer program logic encoded thereon that when performed in a computerized device provides associated operations explained herein. The computer program logic, when executed on at least one processor with a computing system, causes the processor to perform the operations (e.g., the methods) indicated herein as embodiments of the invention. Such arrangements of the invention are typically provided as software, code and/or other data structures arranged or encoded on a computer readable medium such as an optical medium (e.g., CD-ROM), floppy or hard disk or other a medium such as firmware or microcode in one or more ROM or RAM or PROM chips or as an Application Specific Integrated Circuit (ASIC) or as downloadable software images in one or more modules, shared libraries, etc. The software or firmware or other such configurations can be installed onto a computerized device to cause one or more processors in the computerized device to perform the techniques explained herein as embodiments of the invention. Software processes that operate in a collection of computerized devices, such as in a group of storage area network management servers, hosts or other entities can also provide the system of the invention. The system of the invention can be distributed between many software processes on several computers, or all processes could run on a small set of dedicated computers or on one computer alone.

### DETAILED DESCRIPTION OF THE FIGURES

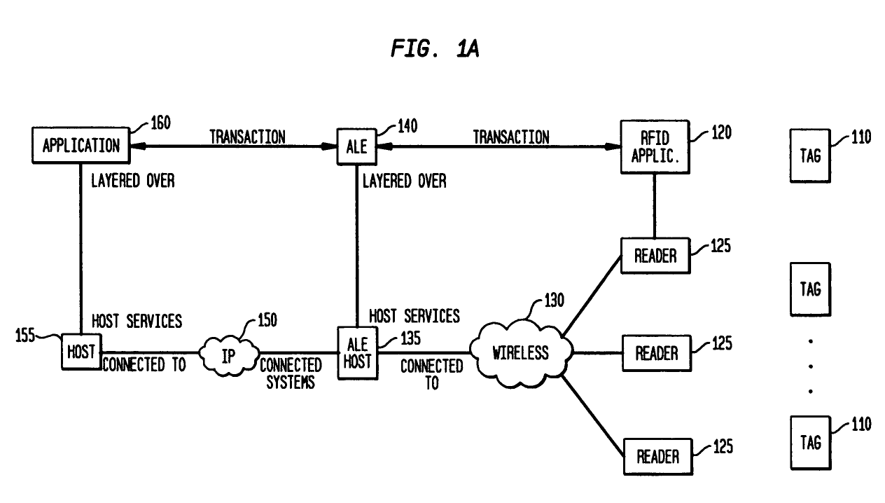

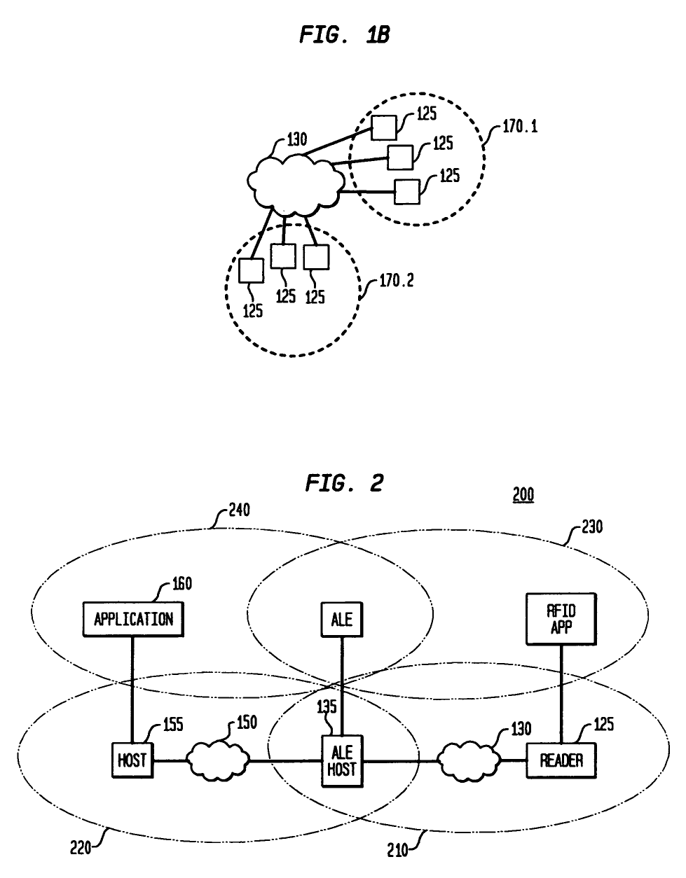

FIGS. 1A and 1B illustrate aspects of a conventional RFID network;

FIG. 2 illustrates an exemplary representation of the RFID network shown in FIGS. 1A and 1B;

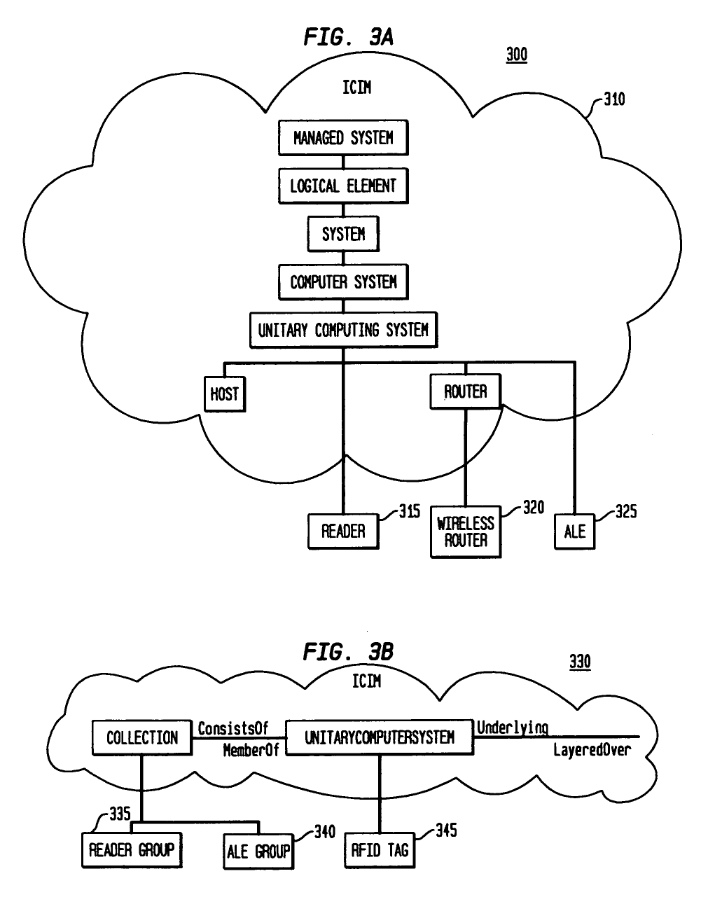

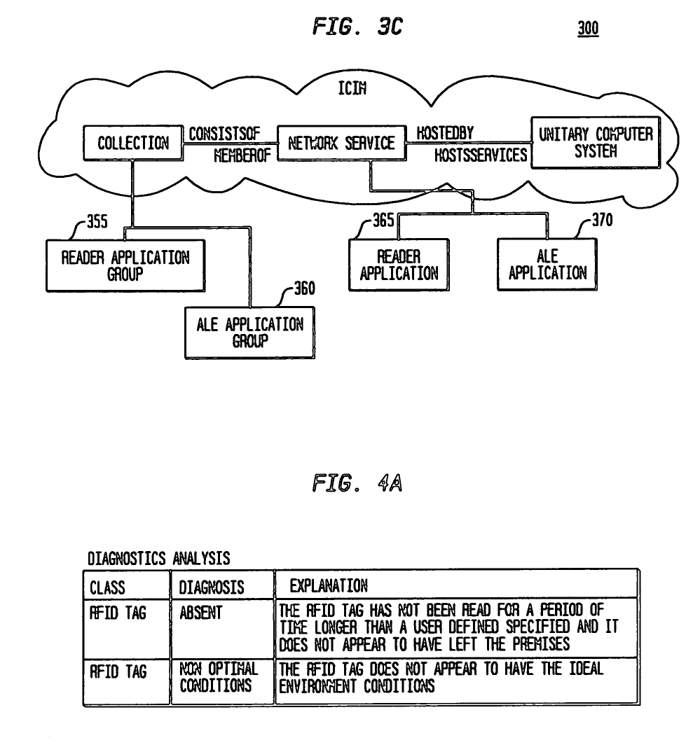

FIGS. 3A-3C illustrates modeling representation of the RFID network in accordance with the principles of the invention;

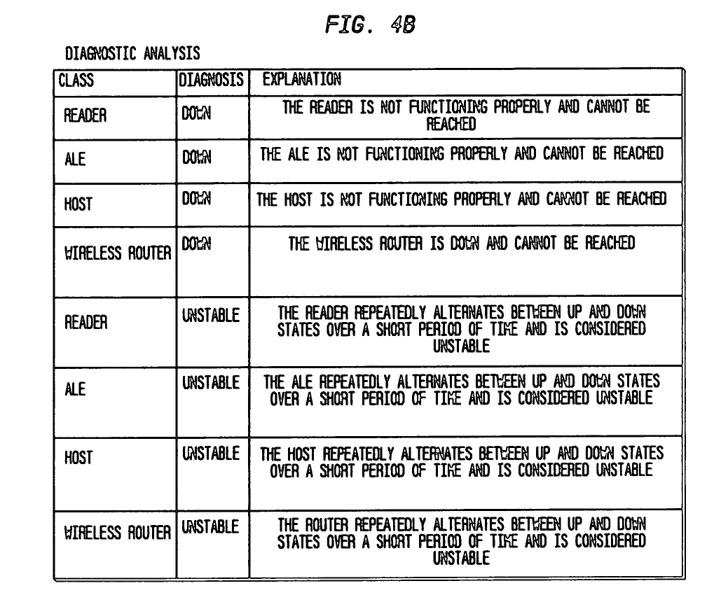

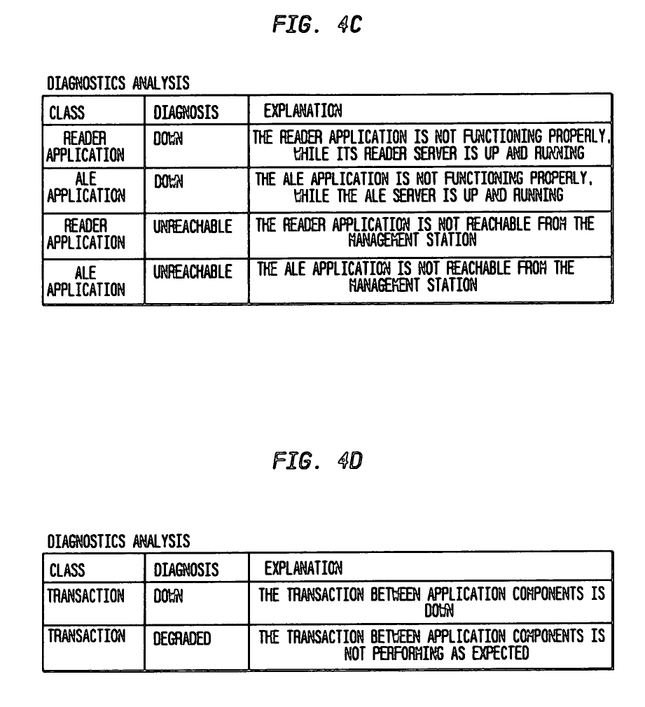

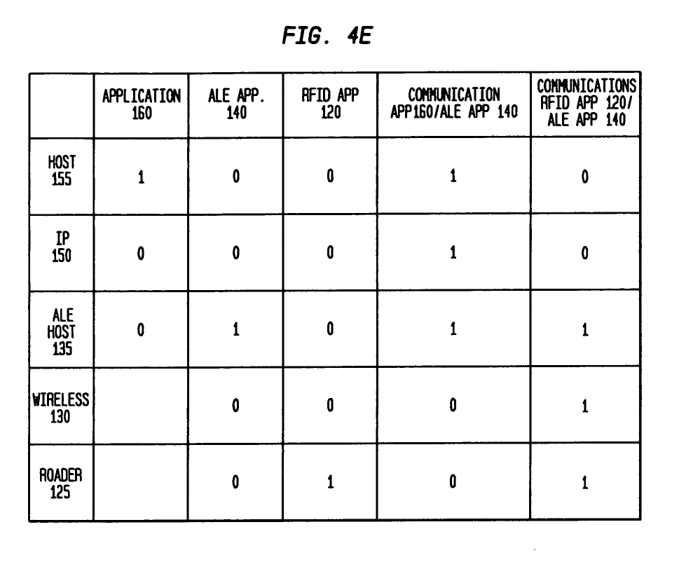

FIGS. 4A-4E illustrate an exemplary diagnostic analysis associated with aspects of the RFID network shown in FIGS. 1A and 1B;

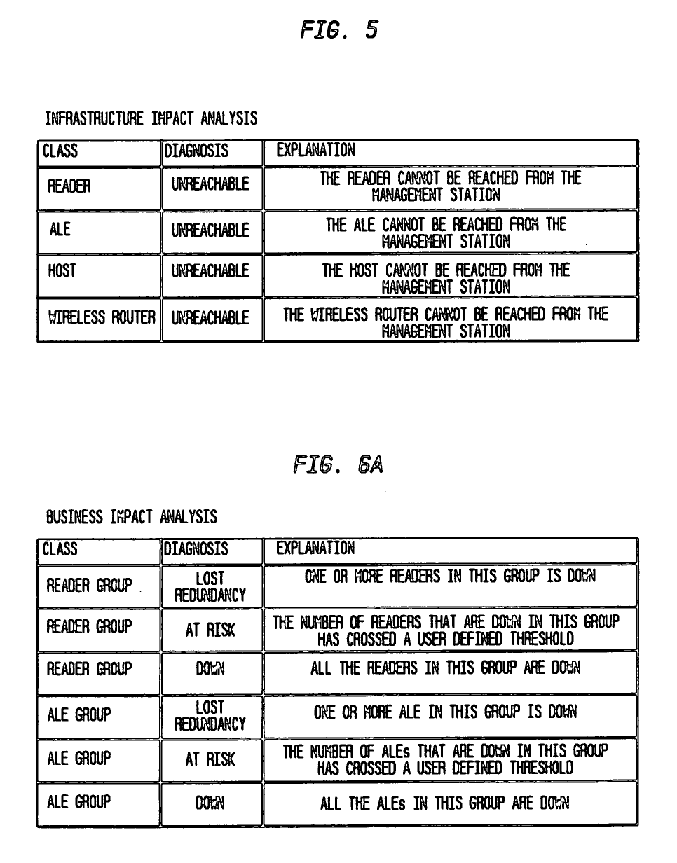

FIG. 5 illustrate an exemplary analysis showing the impact on the infrastructure of the RFID network shown in FIG. 1A;

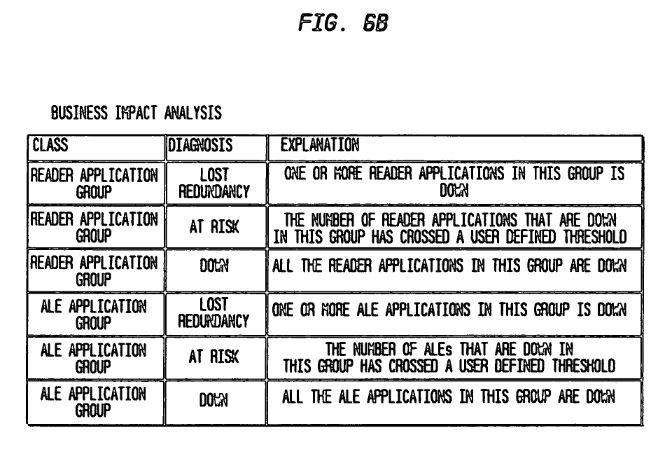

FIGS. 6A and 6B illustrate exemplary analysis of the impact on a business operation when a failure at a lower level in an RFID network occurs; and

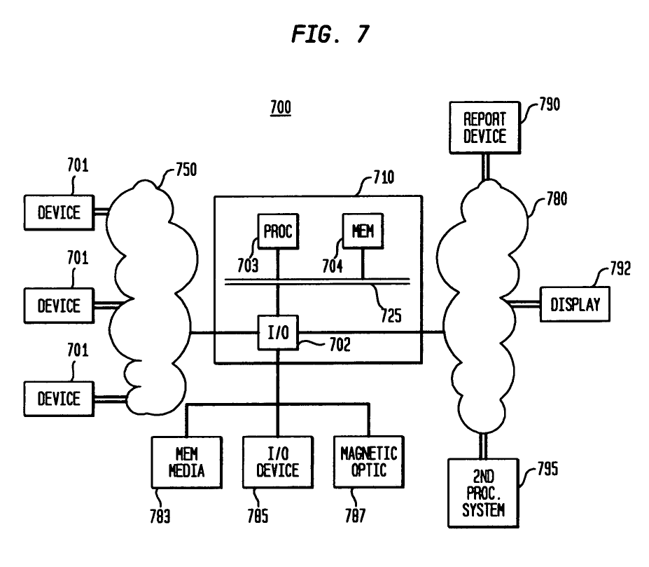

FIG. 7 illustrates a system implementing the processing shown herein.

It is to be understood that these drawings are solely for purposes of illustrating the concepts of the invention and are not intended as a definition of the limits of the invention. The embodiments shown in the figures herein and described in the accompanying detailed description are to be used as illustrative embodiments and should not be construed as the only manner of practicing the invention. Also, the same reference numerals, possibly supplemented with reference characters where appropriate, have been used to identify similar elements.

### DETAILED DESCRIPTION

FIG. 1A illustrates an exemplary conventional RF Identification (RFID) network 100 composed of a RFID reader application 120 included on a RFID reader device 125. As would be appreciated, the RFID reader application 120 may represent a software or computer program that resides or loaded into RFID reader device 125. In this case, the RFID reader application 120 is referred-to as being “hosted-by” the reader device 125. The RFID device 125 is typically a simple device that is able to receive information from the RF tags 110, when the RF tags are within a known range of the RF device 125 and provide this information to a next higher process in the network. RF device 125 is in communication with network 130, which, in this exemplary example is illustrated as a wireless network. Information from reader 125 is provided to host or server 135 through network 130. Host 135 includes—i.e., hosts—an Application Level Events (ALE) 140. ALEs are known in the art and addition information regarding ALEs is available at http://www.rfidjournal.com/article/articleview/1886/1/1/. In one aspect, application ALE may process the inputs provided by a plurality of readers 125 and removes duplicate inputs from subsequent processing. Duplicate inputs may be obtained from the same RFID tag 110, for example, by reader 125 periodically polling the RFID tags 110 within the general transmission/reception area of reader 125.

In the illustrated example shown, host/server 135 is also in communication with a second network 150, represented as an IP network, which is in communication with host/server 155. Host/servers 155 includes at least one application 160 which may be used to process data received from the RFID reader card 120 through host 135. Application 160 for example, may process the data received and format the raw or processed data for subsequent presentation on a display screen (not shown).

Network 100, shown in FIG. 1A, may represent an inventory control system, wherein packages containing one or more RFID tags 110 are pasted before reader(s) 125, which receive information regarding the RFID tag,—e.g., tag identification, package number, package contents, etc. The RFID tag information is provided to host 135, via network 130, for processing by application ALE 140. Host 135 may be a processor or server that is local to a plurality of readers or may be remotely located from a plurality of readers. The processed data, and in cases, raw data, is provided to host 155, via network 150, for processing by application 160. Application 160 may present the processed information to a user on a display system (not shown). In this manner, a centralized user is provided information regarding inventory to better manage the user's supply chain. In another aspect, the RFID reader 125 may be located in the facility of a supplier and information regarding the inventory provided be provided to a purchaser so the user may coordinate activities or deliveries of a plurality of suppliers.

FIG. 1B illustrates an exemplary expansion of the network shown in FIG. 1A. In this case, the RFID readers 125 may be grouped together in groups 170.1, 170.2 etc. The RFID reader groups may be determined based on the geographical location of the readers, the type or style of readers, etc. In the inventory control network example described above, RFID group 170.1 may represent the readers 125 at one location and RFID group 170.2 may represent readers 125 at a second, possibly remote, location. For example, group 170.1 may represent readers at a first supplier facility and group 170.2 may represent readers at a second supplier. Similarly groups 170.1 and 170.2 may represent groups of passive and active, respectively, RFID readers, at the same or at different locations.

FIG. 2 illustrates an exemplary representation of the RFID network shown in FIG. 1A. In this exemplary representation the RFID network is partitioned into logical domains. In this case, the system may be represented by one or more domains wherein components within a domain are associated with known function or operation. Domain 210 represents the infrastructure—i.e., reader 124, network 130, host 135—of the RFID portion of network 100. Domain 220 represents the infrastructure (host 135, network 150, host 155) of the IP portion of network 100. Domain 230 represents the low level application processing (RFID application, ALE) associated with the RFID portion of network 100 and domain 240 represents the higher level application processing (ALE, application). In this representation, host 135 and application ALE 140 represent intersection points between the respective domains. In this case the intersection points are shown with respect to two domains, however, it would be recognized that an intersection point may be a member or included in more than two domains.

FIGS. 3A-3C, collectively, illustrate an exemplary embodiment of an abstract model in accordance with the principles of the present invention. The model shown is an extension of a known network models, such as the EMC/Smarts Common Information Model (ICIM), or similarly defined or pre-existing CIM-based model and adapted for the RFID network. EMC and SMARTS are trademarks of EMC Corporation, Inc., having a principle place of business in Hopkinton, Ma, USA. The EMC/Smarts model is an extension of the well-known DMTF/SMI model. Model based system representation using the ICIM model is discussed in the commonly-owned referred-to related US patents and patent applications, the contents of which are incorporated by reference herein.

Referring to FIG. 3A, this figure illustrates an exemplary abstract model 300 of the RFID infrastructure portion of network 100 in accordance with the principles of the invention. The existing ICIM model 310 includes the elements entitled Managed System, Logical Element, System, Computer System and Unitary Computing System, Host and Router, which represent objects that represent elements of network systems. For example, the object Router represents the parameters and attributes associated with a router system. In addition to the known objects the model is expanded to include the new objects Reader 315, Wireless Router 320 and ALE 325. As would be understood by those skilled in the art, the objects Reader 315, Wireless Router 320 and ALE 325 represent configuration—i.e., network, non-specific configurations representations of the attributes and parameters of the associated hardware and further inherent the attributes and parameters of any associated subclass. Similarly relationships between the objects may be represented to represent the interaction of the objects, e.g., the effect of an event in one object on another object.

FIG. 3B illustrates a second aspect 330 of the model representation of the RFID network shown in FIG. 1A. In this case, objects Reader Group 335 and ALE Group 340 are added to the existing ICIM object Collection. The Reader Group 335 object represents the parameters and attributes of the grouping of readers as shown in FIG. 1B, for example. A similar grouping of ALE elements is shown as ALE 340. Tag object 345 represents the parameters and attributes of the RFID tags 110.

FIG. 3C illustrates another aspect 350 of the model representation of the RFID network shown in FIG. 1A. In this case, the ICIM Collection object further includes the objects Reader Application Group 355 and ALE Application Group 360. Reader Application Group 355 and ALE Application Group 360 are similar to the Reader Group 355 and ALE Group 340. The existing Network Services object is expanded to include the Reader Application 356 and ALE application 370. Reader Application 356 and ALE application 370 objects represent the parameters and attributes of reader 125 and ALE 140, respectively.

It would be understood that the objects associated with the IP network domains 220 and 240 are known in the art as represented in the existing ICIM model and need not be disclosed in further detail herein.

FIGS. 4A-4D illustrate the results of an exemplary diagnostic analysis of failures or problems experienced by network elements as represented by the associated objects. Referring to FIG. 4A, a diagnostic analysis associated with the RFID Tag class is shown. For example, an RFID Tag may be declared “absent” when a tag is not read for a known period of time. Similarly an RFID tag may be declared “non-optimal” when an RFID tag does not appear to have ideal environment conditions.

FIG. 4B illustrates an exemplary diagnostic analysis associated with the RFID infrastructure layer. For example, a Reader class may be declared “down” when the reader cannot be reached—i.e., access to or communication with is not available. A Read class maybe declared “unstable” when it is determined that the reader alternates between up and down states. An unstable state may be subsequently deemed a “down” condition to remove the unstable reader from further consideration. FIG. 4C illustrates a diagnostic analysis associated with the RFID application layer. In this case, a Reader Application may be declared “down” when a reader application is not functioning but the reader is determined to be operational—i.e., up.

FIG. 4D illustrates an exemplary diagnostic analysis associated with transactions occurring between applications. A Transaction may be declared down when the transaction between application components is not working properly—i.e., down.

The information provided in FIGS. 4A-4D, individually or in combination,—i.e., combining information from multiple domains may be used to express a behavior of the network elements and, thus, determine the root-cause of a problem occurring in an RFID network. As an example of a root cause analysis consider a failure occurring in host 135. A failure or problem in host 135 may create detectable events or symptoms in ALE application 140, as ALE application 140 may no longer function properly. The failure in host 135 may further create a detectable event or symptom in host 155 and application 160 when application 160 makes a request to obtain data from RFID tags 110.

In some aspects, although a failure may occur, symptom(s) may or may not be generated to indicate that a component is experiencing failures. A root-cause correlation must be powerful enough to be able to deal with scenarios in which symptoms are generated and not generated to indicate the cause of the failure. In this example, the root-cause correlation determines the host 135 as the root cause. An analysis, e.g., a root cause analysis, of the RFID network, similar to that described in the aforementioned related US patents and patent application, the disclosures of which are incorporated by reference, herein, may be used to determine from the exemplary causality or behavior model(s) shown, herein. As described in the related US patents and patent applications a determination of a measure of the elements of the causality matrix shown may be used to determine the most likely root cause of the one or more of the observed symptoms. In another aspect, the system may be represented by one or more domains containing common functionally components. In this case, the mostly likely event(s) associated with each domain may be correlated to determine a most-likely event(s). In this case, the symptoms or observable events may be associated with components or elements associated with at least two domains—i.e., an intersection point or an association—and the analysis may be preformed with regard to these intersection points.

FIG. 4E illustrates an exemplary causality or behavior model (represented in a matrix form) of the RFID network shown in FIG. 1A. FIG. 4E illustrates, for example, that when a problem in host 135 occurs then application 160 and the communication between application 160 and ALE application 140 may be impacted. In other aspect, if the communication between application 160 and ALE application 140 is not operating properly, the problem may be in Host 135, IP network 150 or ALE host. In this case, the improper operation of the communication between application 160 and ALE application 140 represents an observable event or symptom that occurs dependent upon one or more possible underlying problems.

FIG. 5 illustrates an exemplary impact analysis, i.e., the affect of a failure, associated with the RFID infrastructure domain as shown in FIG. 2. FIGS. 6A and 6B illustrate the impact on a business operation caused by a failure or detected error in the RFID infrastructure and application domains, respectively, as shown in FIG. 2. From the teachings to the referred-to US patents and patent applications, impact and/or behavior models similar to that shown in FIG. 4E may be developed from the information shown in FIGS. 5, 6A and 6B and need not be discussed in detail herein.

FIG. 7 illustrates an exemplary embodiment of a system 700 that may be used for implementing the principles of the present invention. System 700 may contain one or more input/output devices 702, processors 703 and memories 704. I/O devices 702 may access or receive information from one or more sources or devices 701. Sources or devices 701 may be devices such as routers, servers, computers, notebook computer, PDAs, cells phones or other devices suitable for transmitting and receiving information responsive to the processes shown herein. Devices 701 may have access over one or more network connections 750 via, for example, a wireless wide area network, a wireless metropolitan area network, a wireless local area network, a terrestrial broadcast system (Radio, TV), a satellite network, a cell phone or a wireless telephone network, or similar wired networks, such as POTS, INTERNET, LAN, WAN and/or private networks, e.g., INTERNET, as well as portions or combinations of these and other types of networks.

Input/output devices 702, processors 703 and memories 704 may communicate over a communication medium 725. Communication medium 725 may represent, for example, a bus, a communication network, one or more internal connections of a circuit, circuit card or other apparatus, as well as portions and combinations of these and other communication media. Input data from the client devices 701 is processed in accordance with one or more programs that may be stored in memories 704 and executed by processors 703. Memories 704 may be any magnetic, optical or semiconductor medium that is loadable and retains information either permanently, e.g. PROM, or non-permanently, e.g., RAM. Processors 703 may be any means, such as general purpose or special purpose computing system, such as a laptop computer, desktop computer, a server, handheld computer, or may be a hardware configuration, such as dedicated logic circuit, or integrated circuit. Processors 703 may also be Programmable Array Logic (PAL), or Application Specific Integrated Circuit (ASIC), etc., which may be “programmed” to include software instructions or code that provides a known output in response to known inputs. In one aspect, hardware circuitry may be used in place of, or in combination with, software instructions to implement the invention. The elements illustrated herein may also be implemented as discrete hardware elements that are operable to perform the operations shown using coded logical operations or by executing hardware executable code.

In one aspect, the processes shown herein may be represented by computer readable code stored on a computer readable medium. The code may also be stored in the memory 704. The code may be read or downloaded from a memory medium 783, an I/O device 785 or magnetic or optical media, such as a floppy disk, a CD-ROM or a DVD, 787 and then stored in memory 704. Or may be downloaded over one or more of the illustrated networks. As would be appreciated, the code may be processor-dependent or processor-independent. JAVA is an example of processor-independent code. JAVA is a trademark of the Sun Microsystems, Inc., Santa Clara, Calif. USA.

Information from device 701 received by I/O device 702, after processing in accordance with one or more software programs operable to perform the functions illustrated herein, may also be transmitted over network 780 to one or more output devices represented as display 785, reporting device 790 or second processing system 795.

As one skilled in the art would recognize, the term computer or computer system may represent one or more processing units in communication with one or more memory units and other devices, e.g., peripherals, connected electronically to and communicating with the at least one processing unit. Furthermore, the devices may be electronically connected to the one or more processing units via internal busses, e.g., ISA bus, microchannel bus, PCI bus, PCMCIA bus, etc., or one or more internal connections of a circuit, circuit card or other device, as well as portions and combinations of these and other communication media or an external network, e.g., the Internet and Intranet.

While there has been shown, described, and pointed out fundamental novel features of the present invention as applied to preferred embodiments thereof, it will be understood that various omissions and substitutions and changes in the apparatus described, in the form and details of the devices disclosed, and in their operation, may be made by those skilled in the art without departing from the spirit of the present invention. It would be recognized that the invention is not limited by the model discussed, and used as an example, or the specific proposed modeling approach described herein. For example, it would be recognized that the method described herein may be used to perform a system analysis may include: fault detection, fault monitoring, performance, congestion, connectivity, interface failure, node failure, link failure, routing protocol error, routing control errors, and root-cause analysis.

It is expressly intended that all combinations of those elements that perform substantially the same function in substantially the same way to achieve the same results are within the scope of the invention. Substitutions of elements from one described embodiment to another are also fully intended and contemplated.

What is claimed is:

1. A method for analyzing a system including a plurality of Radio Frequency Identification (RFID) components, said method comprising the steps of:
representing selected ones of the plurality of components and relations among the representations of the selected components,
providing a mapping between a plurality of observable events and a plurality of causing events occurring in the selected components; and
determining at least one likely causing event based on at least one of the plurality of observable events by determining a measure between each of a plurality of values associated with the plurality of observable events and the plurality of causing events.

2. The method as recited in claim 1, wherein the step of representing said plurality of components comprises the steps of:
creating configuration non-specific representation of the selected components, wherein the non-specific representations are selected from the group consisting of: Reader, Wireless Router, ALE, RFID Tag, Reader Group, ALE Group, Reader Application Group, ALE Application Group, Reader Application, and ALE Application.

3. The method as recited in claim 1, wherein the step of providing a mapping comprises the steps of:
creating at least one configuration non-specific representation of relations along which the causing events propagate among the selected components, wherein the representations of relations are selected from the group consisting of: is composed of, is a member of, sends data to, receives data from, communicates with, manages, is managed by.

4. The method as recited in claim 1, further comprising the step of:
representing selected ones of the plurality of components, and associated relations, with each of a plurality of domains, wherein at least one of the plurality of components is associated with at least two of the domains;
providing a mapping between a plurality of observable events and a plurality of causing events occurring in components in each of the domains, wherein selected ones of the observable events and causing events are associated with each of the at least one component associated with at least two of the domains;
determining at least one likely causing event based on at least one of the plurality of observable events by determining a measure between each of a plurality of values associated with the plurality of observable events and the plurality of causing events in each domain; and
determining a likely causing event by correlating the likely causing events associated with each of the domains.

5. The method as recited in claim 4, wherein the components associated with the at least two domains are selected from the group consist of: ALE Application and ALE.

6. An apparatus for analyzing a system including a plurality of Radio Frequency Identification (RFID) components, the apparatus comprising:
a processor in communication with a memory, the processor executing computer code for executing the steps of:
representing selected ones of the plurality of components and relations among the representations of the selected components;
providing a mapping between a plurality of observable events and a plurality of causing events occurring in the selected components; and
determining at least one likely causing event based on at least one of the plurality of observable events by determining a measure between each of a plurality of values associated with the plurality of observable events and the plurality of causing events.

7. The apparatus as recited in claim 6, wherein the step of representing the plurality of components comprises the processor executing code for executing the steps of:
creating configuration non-specific representation of the selected components, wherein the non-specific representations are selected from the group consisting of: Reader, Wireless Router, ALE, RFID Tag, Reader Group, ALE Group, Reader Application Group, ALE Application Group, Reader Application, and ALE Application.

8. The apparatus as recited in claim 6, wherein the step of providing a mapping comprises the processor executing code for executing the steps of:
creating at least one configuration non-specific representation of relations along which the causing events propagate amongst the selected components, wherein the representations of relations are selected from the group consisting of: is composed of, is a member of, sends data to, receives data from, communicates with, manages, is managed by.

9. The apparatus as recited in claim 6, wherein the processor further executing code for executing the steps of:
representing selected ones of the plurality of components, and associated relations, which each of a plurality of domains, wherein at least one of the plurality of components is associated with at least two of the domains;
providing a mapping between a plurality observable events and a plurality of causing events occurring in components in each of the domains, wherein selected ones of the observable events are associated with each of the at least one component associated with at least two of the domains;
determining at least one likely causing event based on at least one of the plurality of observable events by determining a measure between each of a plurality of values associated with the plurality of observable events and the plurality of causing events in each domain; and
determining a likely causing event by correlating the likely causing events associated with each of the domains.

10. The apparatus as recited in claim 9, wherein the components associated with the at least two domains are selected from the group consist of: ALE Application and ALE.

11. The apparatus as recited in claim 6, further comprising:
an input/output device in communication with the processor.

12. A computer program product for analyzing a system including a plurality of Radio Frequency Identification (RFID) components by providing instruction to a processor enabling the processor to execute the steps of:
representing selected ones of the plurality of components and relations among the representations of the selected components,
providing a mapping between a plurality of observable events and a plurality of causing events occurring in the selected components; and
determining at least one likely causing event based on at least one of the plurality of observable events by determining a measure between each of a plurality of values associated with the plurality of observable events and the plurality of causing events.

13. The computer program product as recited in claim 12, further providing instruction for enabling the processor to execute the step of:
creating a configuration no-specific representation of the selected components, wherein the non-specific representations are selected from the group consisting of: Reader, Wireless Router, ALE, RFID Tag, Reader Group, ALE Group, Reader Application Group, ALE Application Group, Reader Application, and ALE Application.

14. The computer program product as recited in claim 12, further providing instruction for enabling the processor to execute the step of:
creating at least one configuration non-specification representation of relations along which the causing events propagate amongst the selected components, wherein the representations of relations are selected from the group consisting of: is composed of, is a member of, sends data to, receives data from, communicates with, manages, is managed by.

15. The computer program product as recited in claim 12, further providing instruction for enabling the processor to execute the steps of:
representing selected ones of the plurality of components, and associated relations, with each of a plurality of domains, wherein at least one of the plurality of components is associated with at least two of the domains;
providing a mapping between a plurality of observable events and a plurality of causing events occurring in components in each of the domains, wherein selected ones of the observable events and causing events are associated with each of the at least one component associated with at least two of the domains;
determining at least one likely causing event based on at least one of the plurality of observable events by determining a measure between each of a plurality of values associated with the plurality of observable events and the plurality of causing events in each domain; and
determining a likely causing event by correlating the likely causing events associated with each of the domains.

16. The computer program product as recited in claim 15, wherein the components associated with the at least two domains are selected from the group consist of: ALE Application and ALE.
